(19) United States
(12) Patent Application Publication
(10) Pub. No.: US 2021/0404818 A1
(43) Pub. Date: Dec. 30, 2021

(54) METHOD, APPARATUS, AND SYSTEM FOR PROVIDING HYBRID TRAFFIC INCIDENT IDENTIFICATION FOR AUTONOMOUS DRIVING

(71) Applicant: HERE Global B.V., Eindhoven (NL)

(72) Inventors: Jingwei XU, Chicago, IL (US); Yuxin GUAN, Chicago, IL (US)

(21) Appl. No.: 17/357,584

(22) Filed: Jun. 24, 2021

Related U.S. Application Data
(60) Provisional application No. 63/043,537, filed on Jun. 24, 2020.

(51) Int. Cl. G01C 21/34; G01C 21/32; G01C 21/00

(52) U.S. Cl. CPC G01C 21/3415; G01C 21/3461; G01C 21/3837; G01C 21/3896; G01C 21/32

(57) ABSTRACT

An approach is provided for providing hybrid traffic incident identification. The approach, for example, involves processing traffic incident information received from at least one incident source to classify the traffic incident information as either well-formatted data (matching at least one previously stored incident code) or non-well-formatted data (not matching the previously stored incident code). The approach also involves converting the well-formatted data to an incident reporting format to generate a first output portion. The approach further involves extracting incident content from the non-well-formatted data. The extracted incident content represents the traffic incident information based on the at least one previously stored incident code. The approach further involves converting the extracted incident content to the incident reporting format to generate a second output portion. The approach further involves providing the first output portion and/or the second output portion as a hybrid incident output.

### RELATED APPLICATION

This application claims priority to U.S. Provisional Patent Application Ser. No. 63/043,537, filed Jun. 24, 2020, entitled “METHOD, APPARATUS, AND SYSTEM FOR PROVIDING HYBRID TRAFFIC INCIDENT IDENTIFICATION FOR AUTONOMOUS DRIVING”, which is incorporated herein by reference in its entirety.

### BACKGROUND

Navigation and mapping service providers are continually challenged to provide digital maps with traffic incident reports to support advanced applications such as autonomous driving. For example, providing users up-to-date data on traffic flow and traffic incidents (e.g., accidents or bottlenecks) can potentially reduce congestion and improve safety. However, traffic incident information can come from a lot of different sources: user manual recording, video camera installed on road networks, crowd sources incident data, government sources, etc., with various data formats or no format at all. Therefore, service providers face significant technical challenges to consolidate traffic incident information lacking a consistent data format.

### SOME EXAMPLE EMBODIMENTS

Therefore, there is a need for providing hybrid traffic incident identification when traffic incident information from different sources includes well-formatted data and non-well-formatted data.

According to one embodiment, a method comprises processing traffic incident information received from at least one incident source to classify the traffic incident information as either well-formatted data or non-well-formatted data. The well-formatted data indicates that the traffic incident information matches at least one previously stored incident code, and wherein the non-well-formatted data indicates that the traffic information does not match the previously stored incident code. The method also comprises converting the well-formatted data to an incident reporting format to generate a first output portion. The method further comprises extracting incident content from the non-well-formatted data. The extracted incident content represents the traffic incident information based on the at least one previously stored incident code. The method further comprises converting the extracted incident content to the incident reporting format to generate a second output portion. The method further comprises providing the first output portion, the second output portion, or a combination thereof as a hybrid incident output.

According to another embodiment, an apparatus comprises at least one processor, and at least one memory including computer program code for one or more computer programs, the at least one memory and the computer program code configured to, with the at least one processor, cause, at least in part, the apparatus to process traffic incident information received from at least one incident source to classify the traffic incident information as either well-formatted data or non-well-formatted data. The well-formatted data indicates that the traffic incident information matches at least one previously stored incident code, and wherein the non-well-formatted data indicates that the traffic information does not match the previously stored incident code. The apparatus is also caused to convert the well-formatted data to an incident reporting format to generate a first output portion. The apparatus is further caused to extract incident content from the non-well-formatted data. The extracted incident content represents the traffic incident information based on the at least one previously stored incident code. The apparatus is further caused to convert the extracted incident content to the incident reporting format to generate a second output portion. The apparatus is further caused to provide the first output portion, the second output portion, or a combination thereof as a hybrid incident output.

According to another embodiment, a computer-readable storage medium carries one or more sequences of one or more instructions which, when executed by one or more processors, cause, at least in part, an apparatus to process traffic incident information received from at least one incident source to classify the traffic incident information as either well-formatted data or non-well-formatted data. The well-formatted data indicates that the traffic incident information matches at least one previously stored incident code, and wherein the non-well-formatted data indicates that the traffic information does not match the previously stored incident code. The apparatus is also caused to convert the well-formatted data to an incident reporting format to generate a first output portion. The apparatus is further caused to extract incident content from the non-well-formatted data. The extracted incident content represents the traffic incident information based on the at least one previously stored incident code. The apparatus is further caused to convert the extracted incident content to the incident reporting format to generate a second output portion. The apparatus is further caused to provide the first output portion, the second output portion, or a combination thereof as a hybrid incident output.

According to another embodiment, an apparatus comprises means for processing traffic incident information received from at least one incident source to classify the traffic incident information as either well-formatted data or non-well-formatted data. The well-formatted data indicates that the traffic incident information matches at least one previously stored incident code, and wherein the non-well-formatted data indicates that the traffic information does not match the previously stored incident code. The apparatus also comprises means for converting the well-formatted data to an incident reporting format to generate a first output portion. The apparatus further comprises means for extracting incident content from the non-well-formatted data. The extracted incident content represents the traffic incident information based on the at least one previously stored incident code. The apparatus further comprises means for converting the extracted incident content to the incident reporting format to generate a second output portion. The apparatus further comprises means for providing the first output portion, the second output portion, or a combination thereof as a hybrid incident output.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing a method of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing hybrid traffic incident identification, according to one embodiment;

FIG. 2A is a diagram of an example process for providing hybrid traffic incident identification, according to one embodiment;

FIG. 2B is a data conversion diagram of hybrid traffic incident identification, according to one embodiment;

FIG. 3 is a diagram of components of a traffic platform capable of providing hybrid traffic incident identification, according to one embodiment;

FIG. 4 is a flowchart of a process for providing hybrid traffic incident identification, according to one embodiment;

FIG. 5 is a diagram of components of a hybrid traffic incident event identifier engine capable of providing hybrid traffic incident identification, according to one embodiment;

FIG. 6 is an example table of corresponding message sets for an incident category across different incident reporting standards, according to one embodiment;

FIG. 7 is a flowchart of a process of a video-to-text converter, according to one embodiment;

FIG. 8 is a flowchart of a process for providing hybrid traffic incident identification, according to one embodiment;

FIG. 9 is a flowchart of a process for formatting incident code thereby determining autonomous driving, according to one embodiment;

FIG. 10 is a diagram of an example user interface depicting a traffic incident alert, according to one embodiment;

FIG. 11 is a diagram of a geographic database, according to one embodiment;

FIG. 12 is a diagram of hardware that can be used to implement an embodiment;

FIG. 13 is a diagram of a chip set that can be used to implement an embodiment; and

FIG. 14 is a diagram of a mobile terminal (e.g., handset or vehicle or part thereof) that can be used to implement an embodiment.

### DESCRIPTION OF SOME EMBODIMENTS

Examples of a method, apparatus, and computer program for providing hybrid traffic incident identification are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

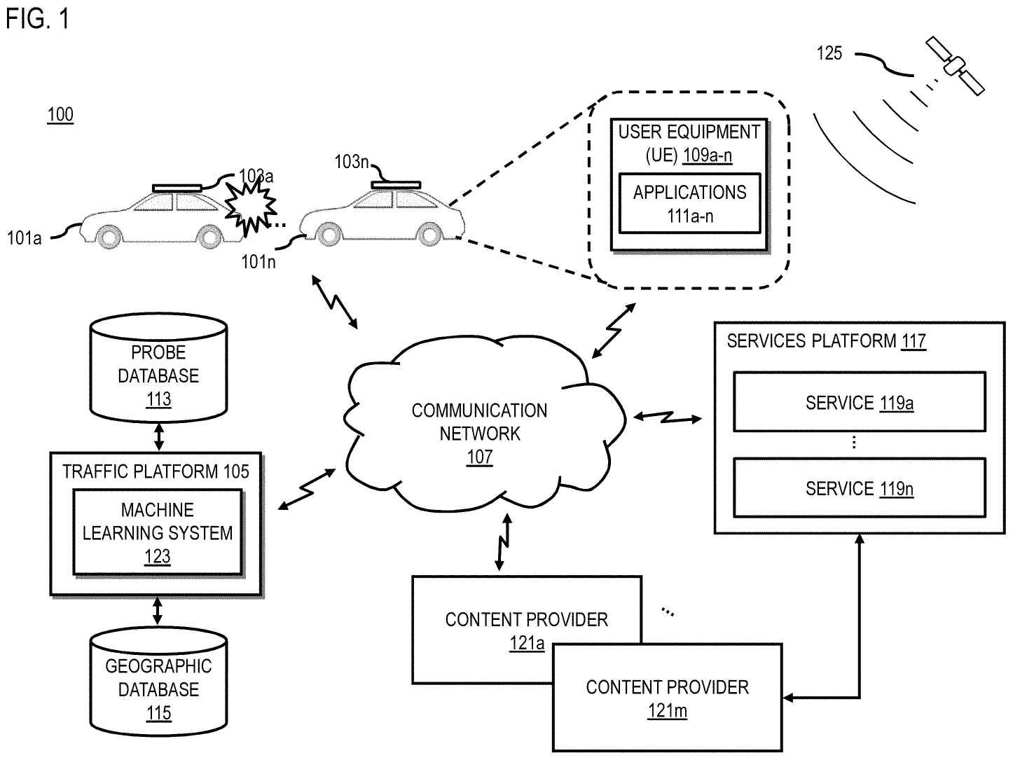

FIG. 1 is a diagram of a system capable of providing hybrid traffic incident identification (i.e., of a road network), according to one embodiment. Automated driving has been a hot trend in recent years and is quickly becoming a reality following advances in machine learning, computer vision, and compute power. Generally, an autonomous vehicle is a vehicle driving on the road without human intervention. The term “autonomous vehicle” is often used interchangeably with driverless car and/or robot car. An autonomous vehicle uses different sensor technologies (e.g., a camera sensor, Light Detection and Ranging (LiDAR), etc.) and a high-definition (HD) map or dynamic backend content including traffic information services to travel on a road network with little or no human intervention.

Providing autonomous or semi-autonomous vehicles with up-to-date data on traffic incidents can reduce congestion and improve safety on the road network. However, obtaining up-to-date data on traffic incidents is particularly challenging. For example, traffic service providers can report real-time static incidents on a specific road segment and send, if appropriate, warning messages to drivers driving upstream ahead of incidents based on multiple input resources (e.g., local or community resources, service providers, regulators, etc.). However, there are many different traffic incident definitions/classifications within the transportation community that lead to more complexity when reporting and managing traffic incidents among different standards or protocols. By way of example, the Traffic Incident Management Handbook defines an incident as “any non-recurring event that causes a reduction of roadway capacity or an abnormal increase in demand.” Under this definition, events such as traffic crashes, disabled vehicles, spilled cargo, highway maintenance and reconstruction projects, and special non-emergency events (e.g., ball games, concerts, or any other event that significantly affects roadway operations) are classified as an incident. The Traffic Management Data Dictionary (TMDD), as published by ITE and AASHTO, defines an incident as “an unplanned randomly occurring traffic event that adversely effects normal traffic operations.” The 2000 Highway Capacity Manual defines an incident as being “any occurrence on a roadway that impedes normal traffic flow.” In addition, traffic incident information reporting into service providers is not always in a machine-readable format, and much less in a standard incident reporting format, such as Alert C code, Transport Protocol Experts Group (TPEG) Traffic Event Compact (TEC) code, etc. Accordingly, mapping service providers face significant technical challenges to consolidate traffic incident infuriation of different forms and formats with confidence and low latency.

To address these problems, the system 100 of FIG. 1 introduces a capability to provide hybrid traffic incident identification (i.e., of a road network), by ingesting traffic incident information from multiple incident sources on predetermined parts of the road network, dynamically evaluating each of multiple incident sources in a road network, and determining whether the traffic incident information per source is well-formatted. When matching the traffic incident information with an incident pattern log, the system 100 can convert the well-formatted traffic incident information into Alert-C code or TPEG TEC code. Otherwise, the system 100 can use natural language processing (NLP) and machine learning (e.g. a deep neural network, DNN) on the non-well-formatted traffic incident information to extract text content and to analyze the text content for incident content. The system 100 can then assign the incident content an incident type, a severity level, and a confidence level/interval (i.e., an occurrence probability), and convert the incident content into Alert-C code or TPEG TEC code. Based on the Alert-C code or TPEG TEC code, the system 100, for example, can decide to enable/disable autonomous driving for a vehicle.

It is noted that the term “traffic incident” refers to any occurrence on a roadway that impedes normal traffic flow. As such, traffic incidents include any recurring or non-recurring events that cause a reduction of roadway capacity or an abnormal increase in demand, such as traffic crashes, disabled vehicles, spilled cargo, highway maintenance and reconstruction projects, and special non-emergency events (e.g., ball games, concerts, or any other event that significantly affects roadway operations).

The term “well-formatted” refers to any traffic incident information following at least one industrial traffic data exchange standard, such as Datex II, radio data system (RDS) traffic message channel (TMC), TPEG TEC, cooperative awareness message (CAM), decentralized environmental notification message (DENM), etc.

The Society of Automotive Engineers International defines driving automation are six levels: Level 0 (automated system has no sustained vehicle control), Level 1 (“hands on”), Level 2 (“hands off”), Level 3 (“eyes off”), Level 4 (“mind off”), and Level 5 (“steering wheel optional”). The system 100 can improve dynamic traffic content delivery on HAD in an open location platform pipeline (OLP) for Level 3 or above autonomous driving. The system 100 can improve driver and/or vehicle awareness of the current state of the road network via the traffic status data of safety messages for all levels 0-5 in a vehicle-to-everything (V2X) communication scheme and big data environment.

In one embodiment, the OLP pipeline can be implemented as a software pipeline application where a series of data processing elements is encapsulated into a reusable pipeline component, and each OLP pipeline can process input data in streams or batches and outputs the results to a specified destination catalog.

In addition, the system 100 can aggregate traffic incident information from various sources into hybrid incident data, then use the hybrid incident data to dynamically optimize route calculations. Moreover, the system 100 can output the hybrid incident data to better design traffic incident reporting and management strategies, such as assessing affected areas under the average and the worst incident scenarios, patrol vehicle distribution around freeway segments, identifying hazardous highway segments for safety and operations concerns, etc.

In one embodiment, the system 100 collects a plurality of instances of probe data, vehicle sensor data, and/or traffic incident information from one or more vehicles 101a-101n (also collectively referred to as vehicles 101) (e.g., autonomous vehicles, HAD vehicles, semi-autonomous vehicles, etc.) having one or more vehicle sensors 103a-103n (also collectively referred to as vehicle sensors 103) (e.g., global positioning system (GPS), LiDAR, camera sensor, etc.) and having connectivity to a traffic platform 105 via a communication network 107. In one instance, the real-time probe data may be reported as probe points, which are individual data records collected at a point in time that records telemetry data for that point in time. A probe point can include attributes such as: (1) probe ID, (2) longitude, (3) latitude, (4) heading, (5) speed, and (6) time.

In one instance, the system 100 can also collect the real-time probe data, sensor data, and/or traffic incident information from one or more user equipment (UE) 109a-109n (also collectively referenced to herein as UEs 109) associated with the a vehicle 101 (e.g., an embedded navigation system), a user or a passenger of a vehicle 101 (e.g., a mobile device, a smartphone, etc.), or a combination thereof. In one instance, the UEs 109 may include one or more applications 111a-111n (also collectively referred to herein as applications 111) (e.g., a navigation or mapping application). In one embodiment, the probe data and/or sensor data collected may be stored in a probe database 113, a geographic database 115, or a combination thereof.

In one instance, the system 100 may also collect real-time probe data, sensor data, and/or traffic incident information from one or more other sources such as government/municipality agencies, local or community agencies (e.g., a police department), and/or third-party official/semi-official sources (e.g., a services platform 117, one or more services 119a-119n, one or more content providers 121a-121m, etc.).

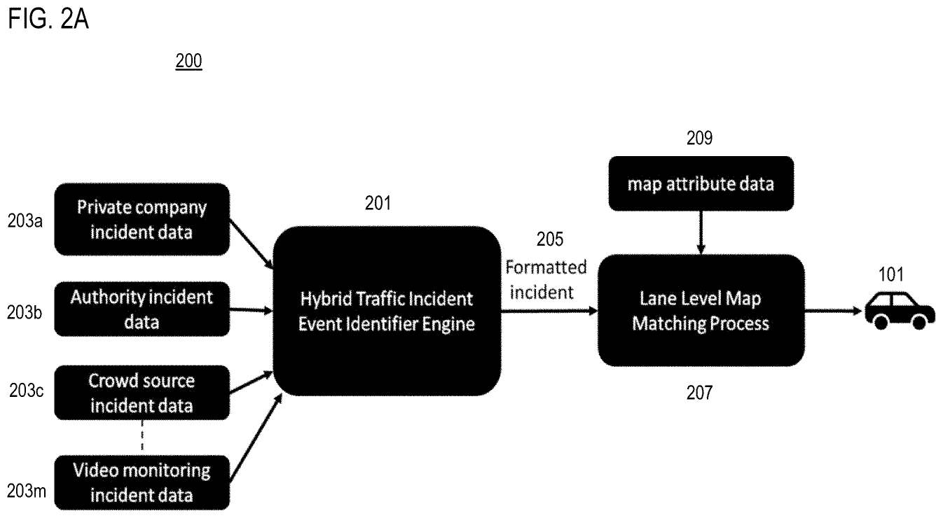

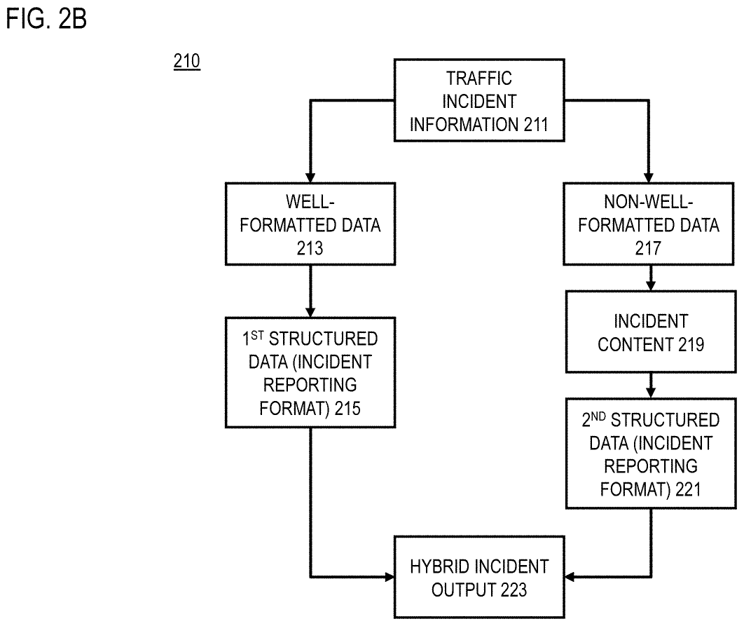

FIG. 2A is a diagram of an example process 200 for providing hybrid traffic incident identification, according to one embodiment. In one embodiment, the system 100 includes a hybrid traffic incident event identifier engine 201 that can process traffic incident information 203 including private company incident data 203a, authority incident data 203b, crowdsourced incident data 203c, . . . , video monitoring incident data 203m, etc., to provide formatted incident data 205 that is in a target traffic incident reporting format. In one embodiment, the system 100 can then perform a lane-level map-matching process 207 on the formatted incident data 205 using map attributed data 209 (e.g., high-definition (I-ID) map data), to add incident location data and/or improve the accuracy of the incident location data.

In one embodiment, the private company incident data 203a can include location-based traffic incident data aggregated by private companies based on trajectory data of probes such as vehicles, mobile devices, etc. The vehicles can include highly automated vehicles (HAVs) operating on public roads, etc. In one embodiment, the authority incident data 203b can include traffic incident feeds, traffic crash reports, police reports, etc. published by public authorities.

In one embodiment, the crowdsourced incident data 203c can include user-reported accidents, traffic jams, speed, and police traps, etc., via navigation and/or map applications such Waze®, etc. In one embodiment, the video monitoring incident data 203m can include traffic monitoring camera data, etc.

FIG. 2B is a data conversion diagram 210 of hybrid traffic incident identification, according to one embodiment. In one embodiment, when the hybrid traffic incident event identifier engine 201 determines the traffic incident information 211 includes well-formatted data 213, such as Datex II, RDS TMC, TPEG TEC, CAM, DENM, etc., the hybrid traffic incident event identifier engine 201 can pattern-match the well-formatted data 213 to a target traffic incident reporting format (e.g., Alert-C or TPEG TEC) to provide first structured data 215. In one embodiment, the system 100 can binary-encode each traffic incident and send it as a traffic message channel (TMC) message including an event code, a location code, an expected incident duration, affected extent, etc. TMC delivers traffic and travel information to motor vehicle that is digitally coded using the ALERT C or TPEG protocol into RDS Type 8A groups carried via conventional FM radio broadcasts. For example, a TMC/Alert-C message can include elements listed in Table 1:

TABLE 1
PI code => Program Identification
Group code => message type identification
B0 => version code
TP => Traffic Program
PTY => Program Type
T, F, D => Multi Group messages DP => Duration and Persistence
D => Diversion Advice
PN => +/− direction
Extent => event extension
Event => event code (see TMDD—Traffic Management Data Dictionary)
Location => location code (DAT Location Table - TMCF-LT-EF-MFF-v06)

When the hybrid traffic incident event identifier engine 201 determines the traffic incident information 211 includes non-well-formatted data 217, such as text (e.g., xml (extensible markup language), json (JavaScript object notation), etc.), audio, video, etc., the hybrid traffic incident event identifier engine 201 can use natural language processing (NLP) and machine learning (e.g. a deep neural network, DNN) to extract text content and to analyze the text content for incident content 219.

In one embodiment, the target traffic incident reporting format includes the following three attributes (by way of illustration and not limitation): (1) an incident type, (2) a severity level, and (3) a confidence level. The system 100 can then convert the incident content 219 an incident type, a severity level, and a confidence level, and convert the incident content 219 into the target traffic incident reporting format (e.g., Alert-C or TPEG TEC) to provide second structured data 221. Based on the first structured data 215 and/or the second structured data 221, the system 100 can provide a hybrid incident output 223, for example, to enable/disable autonomous driving for a vehicle

In one embodiment, the traffic incident information 211 is received directly from the vehicle 101. In this embodiment, vehicle 101 can be configured to report probe data, sensor data, and/or traffic incident information (e.g., via a vehicle sensor 103, a UE 109, or a combination thereof), which are individual data records collected at a point in time that records telemetry data for the vehicle 101 for that point in time. In another embodiment, the traffic incident information 211 is received from one or more third party data aggregators, the probe database 113, the geographic database 115, or a combination thereof.

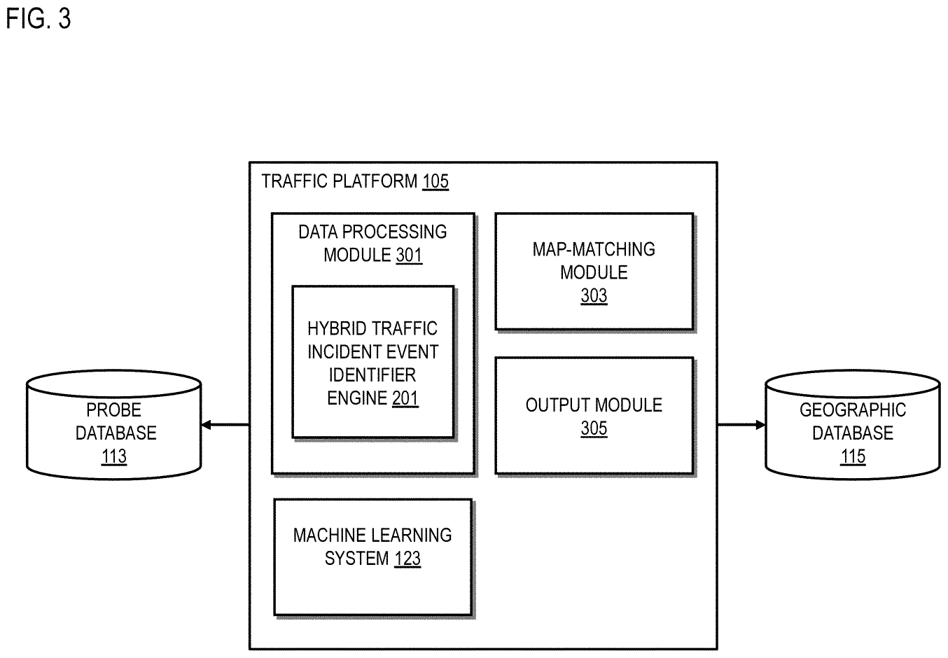

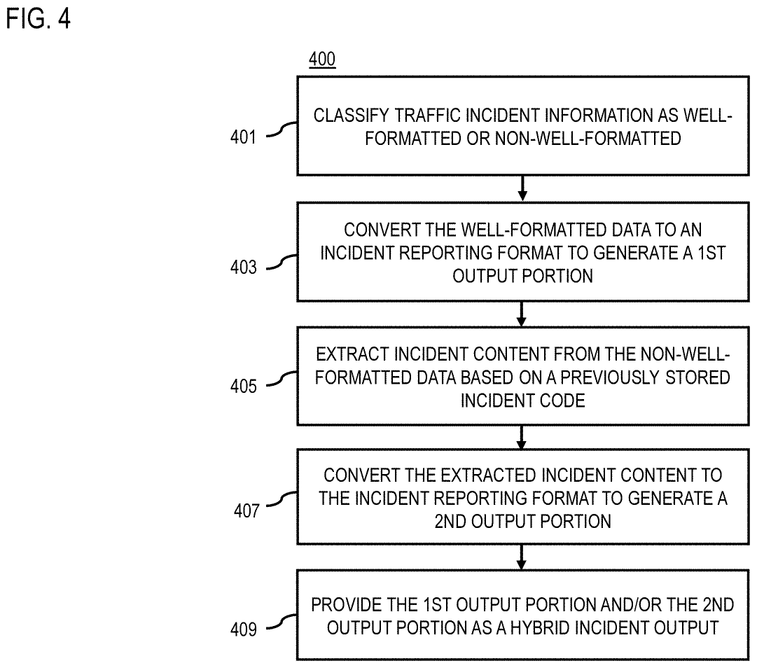

FIG. 3 is a diagram of the components of the traffic platform 105, according to one embodiment. By way of example, the traffic platform 105 includes one or more components for providing hybrid traffic incident identification, according to the various embodiments described herein. It is contemplated that the functions of these components may be combined or performed by other components of equivalent functionality. In one embodiment, the traffic platform 105 includes a data processing module 301, a map-matching module 303, an output module 305, and a machine learning system 123 has connectivity to the probe database 113 and the geographic database 115. The above presented modules and components of the traffic platform 105 can be implemented in hardware, firmware, software, or a combination thereof. Though depicted as a separate entity in FIG. 1, it is contemplated that the traffic platform 105 may be implemented as a module of any other component of the system 100. In another embodiment, the traffic platform 105, the machine learning system 123, and/or the modules 301-305 may be implemented as a cloud-based service, local service, native application, or combination thereof. The functions of the traffic platform 105, the machine learning system 123, and/or the modules 301-305 are discussed with respect to FIG. 4.

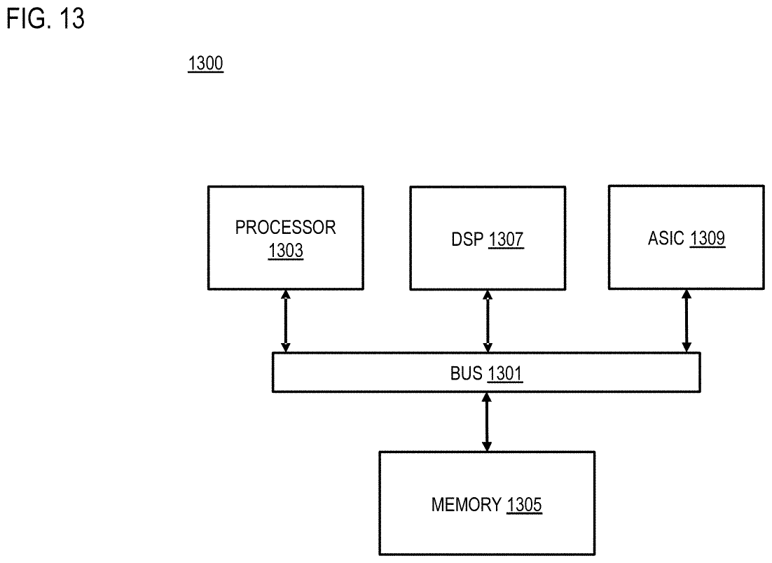

FIG. 4 is a flowchart of a process for providing hybrid traffic incident identification, according to one embodiment. In various embodiments, the traffic platform 105, the machine learning system 123, and/or any of the modules 301-305 may perform one or more portions of the process 400 and may be implemented in, for instance, a chip set including a processor and a memory as shown in FIG. 13. As such, the traffic platform 105 and/or the modules 301-305 can provide means for accomplishing various parts of the process 400, as well as means for accomplishing embodiments of other processes described herein in conjunction with other components of the system 100. Although the process 400 is illustrated and described as a sequence of steps, its contemplated that various embodiments of the process 400 may be performed in any order or combination and need not include all the illustrated steps.

In one embodiment, the hybrid traffic incident event identifier engine 201 of the data processing module 301 can input the traffic incident information 211 for processing. In step 401, the hybrid traffic incident event identifier engine 201 can process traffic incident information 211 received from at least one incident source to classify as either well-formatted data 213 or non-well-formatted data 217. As mentioned, the well-formatted data 213 indicates that the traffic incident information matches at least one previously stored incident code, while the non-well-formatted data 217 indicates that the traffic incident information does not match the previously stored incident code.

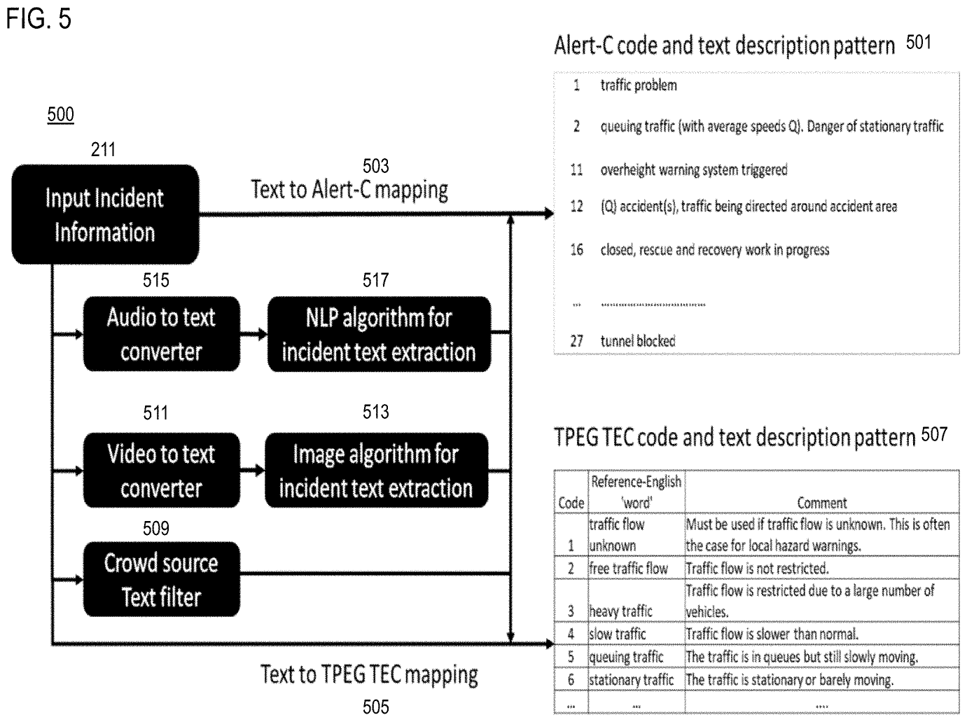

In one embodiment, the traffic incident information includes non-textual data, and the hybrid traffic incident event identifier engine 201 can convert the non-textual data to textual data to generate the well-formatted data, the non-well-formatted data, or a combination thereof. By way of example, FIG. 5 is a diagram 500 of a hybrid traffic incident event identifier engine capable (e.g., the engine 201) of providing hybrid traffic incident identification, according to one embodiment.

In step 403, the hybrid traffic incident event identifier engine 201 can convert the well-formatted data 213 to an incident reporting format to generate a first output portion 215. In one embodiment, the well-formatted data 213 reports traffic incidents in XML, or JSON, including the type and location of each traffic incident, status, start and end time, and other relevant data. The hybrid traffic incident event identifier engine 201 can reformat the well-formatted data 213 into structural data based on the at least one previously stored code.

By way of example, the well-formatted data 213 is retrieved from government highway patrol incident source log, and a snapshot example of a fire is listed in Table 1 as follows. Although the fire incident log is well formatted, the hybrid traffic incident event identifier engine 201 can filter and reformat it to either Alert-C or TPEG TEC code using one or more algorithms. Similar processing can be applied to other traffic incident sources. For example, filter parameters can include criticality, end time, max results, profile, start time, status, tables, type, verified, etc.

In one embodiment, the hybrid traffic incident event identifier engine 201 can convert the structural data in Table 2 to an incident reporting format (e.g., Alert-C code and text description 501) to generate the first output portion 215 based on matching/mapping the structural data to an incident log pattern (e.g., text to Alert-C mapping 503).

TABLE 2

<Log ID=“190813SA01327”>
<LogTime>“Aug 13 2019 10:07PM”</LogTime>
<LogType>“FIRE-Report of Fire”</LogType>
<Location>“9521 Mira Del Rio Dr”</Location>
<LocationDesc>“”</LocationDesc>
<Area>“East Sac”</Area>
<ThomasBrothers>“”</ThomasBrothers>
<LATLON>“38575853:121344638”</LATLON>
<LogDetails>
<details>
<DetailTime>“Aug 13 2019 10:09PM”</DetailTime>
<IncidentDetail>“[3] XFER SAC FIRE” </IncidentDetail>
</details>
<details>
<DetailTime>“Aug 13 2019 10:09PM”</DetailTime>
<IncidentDetail>
“[2] GROUP OF JUVS SET OFF A FIRE WORK AND STARTED
A FIRE”
</IncidentDetail>
</details>
<units>
<UnitTime>“Aug 13 2019 10:12PM”</UnitTime>
<UnitDetail>“Unit Assigned”</UnitDetail>
</units>
</LogDetails>
</Log>

By way of example, the hybrid traffic incident event identifier engine 201 can determine an incident type (e.g., 1084: house fire), an incident severity (e.g., secondary), a confidence level (e.g., 100%), of the determination or a combination of the structured data (e.g., the fire incident log) in Table 3 based on the well-formatted data in Table 2.

TABLE 3
. . .
<EventCode level=“Secondary”>1084</EventCode><EventConfidence
level=“100%”>
. . .

In another embodiment, the hybrid traffic incident event identifier engine 201 can convert the structural data in Table 2 to an incident reporting format (e.g., TPEG TEC code and text description 505) to generate the first output portion 215 based on matching/mapping the structural data to an incident log pattern (e.g., text to TPEG TEC mapping 507). The TPEG TEC protocol is a compact application for traffic event/incident information. TPEG2-TEC is optimized to support dynamic route guidance navigation devices. TPEG can be carried over different transmission media/bearers, such as digital broadcast, cellular networks, etc.

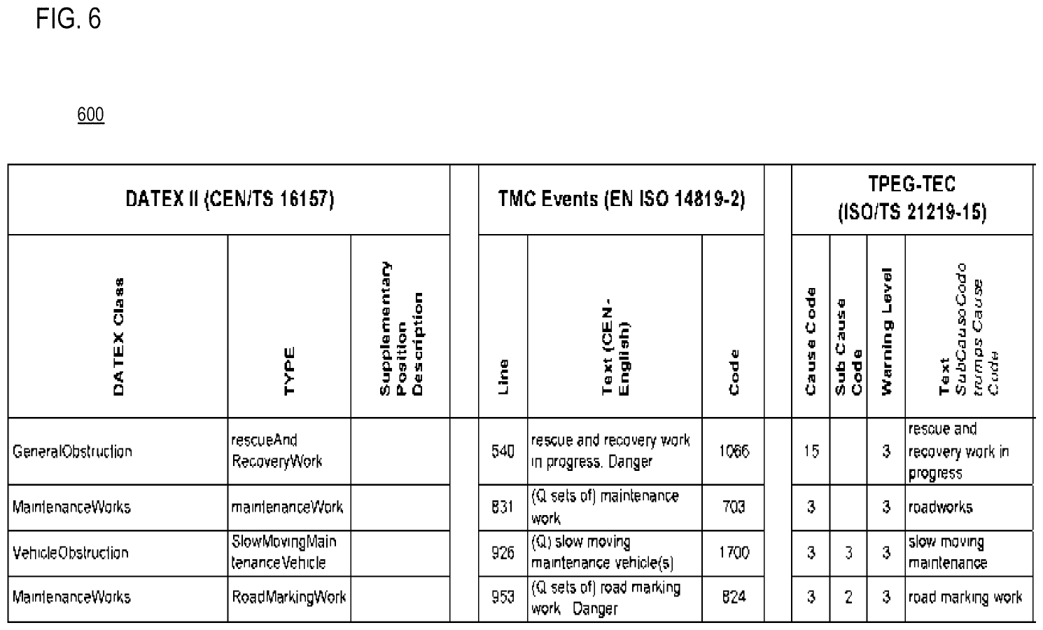

FIG. 6 is an example table 600 of corresponding message sets for an incident category across different incident reporting standards, according to one embodiment. In one embodiment, Table 600 lists four DATEX II short term road work types, corresponding TMC Event codes, and corresponding TPEG2-TEC codes. Short-term road works can be any temporary road works that are carried out on the road or on the side of the road and which are indicated only by minimum signing because of the short-term nature of these works.

By way of example, the first listed short-term road work in DATEX II [class: GeneralObstruction, event type: rescueAnd RecoveryWork] corresponds to TMC [line: 541, text: rescue and recovery work in progress. Danger, code: 1066], and TPEG2-TEC [cause code: 15, warning level: 3, text: rescue and recovery work in progress]. The hybrid traffic incident event identifier engine 201 can convert/map incident event types using conversion tables like the one depicted in FIG. 6.

In one embodiment, the data processing module 301 can store the conversion tables in a local incident database. In another embodiment, the data processing module 301 can store the conversion tables in the geographic database 115.

In step 405, the hybrid traffic incident event identifier engine 201 can extract incident content 219 from the non-well-formatted data 217. The extracted incident content 219 represents the traffic incident information 211 based on the at least one previously stored incident code (e.g., Alert-C or TPEG TEC code). In one embodiment, the non-well-formatted data 217 includes the crowdsourced incident data 203c in text format.

In step 407, the hybrid traffic incident event identifier engine 201 can convert the extracted incident content to the incident reporting format to generate a second output portion 221. Referring back to the crowdsourced incident data 203c example, since the data is already textual, the hybrid traffic incident event identifier engine 201 can apply a text filter 509 on the crowdsourced incident data 203c to extract from the text content (in xml, json, etc.) elements of either Alert-C or TPEG TEC code.

In one embodiment, the hybrid traffic incident event identifier engine 201 can determine an incident type, an incident severity, a confidence level, of the determination or a combination of the structured data based on the non-well-formatted data. By way of example, a user marked via Waze® a severe car crash and road blocked at 38.852069, −77.400850 on Jun. 8, 2020 2:30 μm. The text filter 509 can extract the location, time, and “traffic jam” data to generate a TMC Alert-C message similar to what is in Table 3. In this instance, the instance type is “car crash,” an incident severity is “primary”, and a confidence level “85%.” In one embodiment, the hybrid traffic incident event identifier engine 201 can determine the confidence level based on the individual user statistically reporting reliability. In one embodiment, the hybrid traffic incident event identifier engine 201 can determine the confidence level based on a majority of users reporting of the same incident in the proximity of the location.

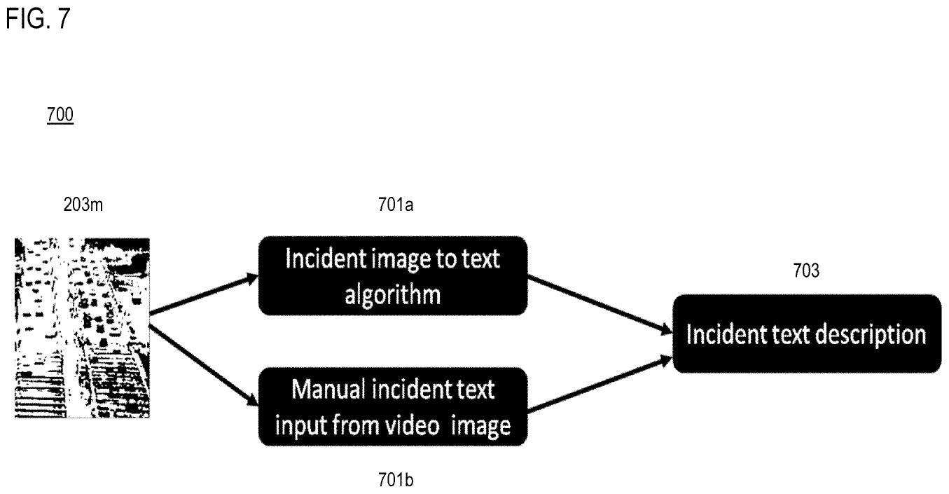

In one embodiment, the non-well-formatted data 217 includes the video monitoring incident data 203m. The hybrid traffic incident event identifier engine 201 can apply a video-to-text converter 511 on the video monitoring incident data 203m. The video-to-text converter 511 can be implemented via software (e.g., algorithm), hardware (e.g., a general processor), and/or firmware. FIG. 7 is a flowchart 700 of a process of a video-to-text converter, according to one embodiment. By way of example, given a video image, either an image-to-text algorithm can identify an incident pattern (e.g., traffic jams, vehicle crashes, road works, etc.) therein in step 701a, or an experiences traffic edit operator can manually input incident text description 703 according to the operator's knowledge and experience in step 701b, thereby provide incident content 219. Concurrently or alternatively, the video-to-text converter 511 works in conjunction with one or more machine learning algorithms 513 (e.g. a deep neural network, DNN) to extract text elements of either Alert-C or TPEG TEC code from the incident content 219.

In one embodiment, the non-well-formatted data 217 includes audio incident data. The hybrid traffic incident event identifier engine 201 can apply an audio-to-text converter 515 on the audio incident data. The audio-to-text converter 515 can be implemented via software (e.g., algorithm), hardware (e.g., a general processor), and/or firmware. By way of example, given an audio clip, either a natural language processing (NLP) algorithm 517 can identify an incident pattern therein (e.g., the text of “traffic jam”, etc.), or an experiences traffic edit operator can manually input incident text description according to the operator's knowledge and experience, thereby provide incident content 219. The NLP algorithm 517 can use machine learning algorithms to extract and translate human's natural languages with accurate meaning behind the input audio or text information data. Concurrently or alternatively, the video-to-text converter 511 works in conjunction with one or more machine learning algorithms (e.g. a deep neural network, DNN) to extract text elements of either Alert-C or TPEG TEC code from the incident content 219.

In step 409, the hybrid traffic incident event identifier engine 201 can provide the first output portion 215, the second output portion 221, or a combination thereof as a hybrid incident output 223.

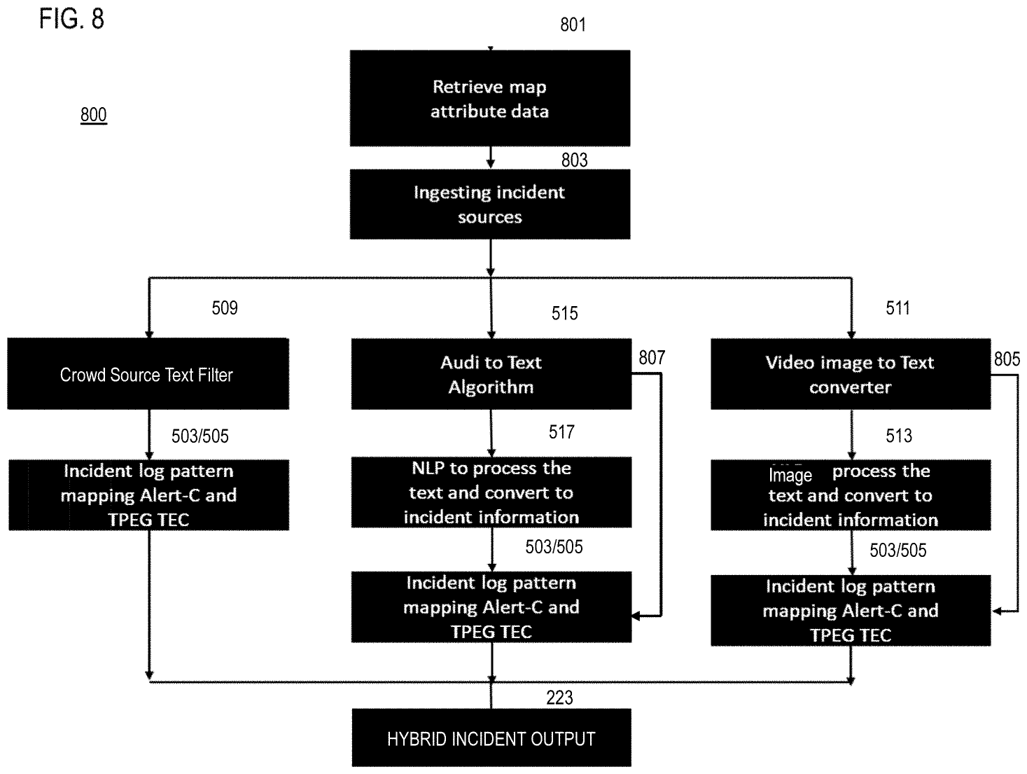

FIG. 8 is a flowchart of a process 800 for providing hybrid traffic incident identification, according to one embodiment. The process 800 adds steps 801-803 into the diagram 500. In FIG. 8, the data processing module 301 can retrieve map attribute data 209 on each road segment in a geographical area in step 801 (prior to the hybrid traffic incident identification by the hybrid traffic incident event identifier engine 201, instead of after the hybrid traffic incident identification as depicted in FIG. 2A).

In one embodiment, the data processing module 301 can design and create a local incident database storing RDS-TMC and/or TPEG TEC incident code with text descriptions. In another embodiment, the data processing module 301 can store RDS-TMC and/or TPEG TEC incident code with text descriptions in the geographic database 115.

The data processing module 301 can ingest traffic incident information 211 from incident sources on predetermined parts of the road network for the hybrid traffic incident event identifier engine 201 in step 803.

As discussed, the traffic incident information 211 can be different formats (e.g., audio, text xml or j son file, etc.) from different resources (e.g., government resources, crowd sourcing, manual input, etc.) Then after, the process 800 can proceed to the diagram 500 as executed by the hybrid traffic incident event identifier engine 201 to process traffic incident information in text, audio, video formats in parallel, and consolidate the Alert-C or TPEG TEC code from three pipelines into the hybrid incident output 223. The hybrid traffic incident event identifier engine 201 can determine whether the input incident information 211 is well formatted or not. If so, the traffic incident information 211 following some industry standards, such as Datex II, RDS TMC, TPEG TEC, etc., in incident text description pattern log can be converted to Alert-C code and/or TPEG TEC code. Otherwise, the hybrid traffic incident event identifier engine 201 an convert the non-well-formatted data to text then to Alert-C code and/or TPEG TEC code using different algorithms. In case of audio data, the hybrid traffic incident event identifier engine 201 can convert the audio data to text using an audio-to-text algorithm, then use NLP to extract incident content, and to filter and analyze the incident content for elements of the Alert-C code and/or TPEG TEC code (including an incident type, a severity level, a confidence level, etc.). In case of video data, the hybrid traffic incident event identifier engine 201 can convert the video data to text information using image processing algorithm or manually via an experienced operator, then extract incident content, and to filter and analyze the incident content for elements of the Alert-C code and/or TPEG TEC code.

In FIG. 8, rather than the discussed 2-step process (video-to-text then text-to-code), the hybrid traffic incident event identifier engine 201 applies an image machine learning model that directly coverts video-to-code in step 805. By analogy, rather than the discussed 2-step process (audio-to-text then text-to-code), the hybrid traffic incident event identifier engine 201 applies an image machine learning model that directly coverts audio-to-code in step 807.

Referring back to FIG. 2, the traffic incident information 211 can be different format (audio, text xml or j son file . . . ) from different resources (government resources, crowd sourcing, manual input . . . ). When the traffic incident information 211 is the well-formatted data 213 following certain industry standard (e.g., Datex II, RDS TMC, TPEG TEC, etc.), the hybrid traffic incident event identifier engine 201 can extract elements of an incident reporting format (including an incident type, an incident severity, a confidence level, etc.) based on conversion tables (e.g., FIG. 6). Otherwise, when the traffic incident information 211 is the non-well-formatted data 217 (e.g., textual, audio, video, etc. not following any industry standard), the hybrid traffic incident event identifier engine 201 can either (1) directly extract the elements of an incident reporting format from the non-well-formatted data 217 using machine learning; or (2) converting the non-well-formatted data 217 into incident content 219 (including converting audio/video into text), and then extract the elements of an incident reporting format from the incident content 219 using machine learning. Applicable machine learning algorithms may include a neural network, support vector machine (SVM), decision tree, k-nearest neighbors matching, etc.

In one embodiment, a traffic incident machine learning model can be built based on the traffic incident information 211, the well-formatted data 213, the non-well-formatted data 217, the incident content 219, and/or the hybrid incident output 223 as training data. By way of example, the machine learning system 123 can determine elements of an incident reporting format (including an incident type, an incident severity, a confidence level, etc.) using parameters that describe a distribution or a set of distributions of the traffic incidents from different sources one road segments, thereby calculating a confidence level of a traffic incident (with a respective incident type, a respective incident severity, etc.) as reported.

In the above-discussed embodiments, the audio-to-text converting through NLP algorithms or the like, and the video-to-text converting through image processing algorithms or the like can: (1) extract traffic incident content from incoming incident sources considering the different syntax and semantics of their messages in the log files and interpret the context for incident description and incident code assignment; (2) extract patterns and correlations in an incident database of incident logs to reveal knowledge of conversion (e.g., conversion tables across standards, etc.) and assign incident code; and (3) extract hidden incident content inside text data through pattern recognition.

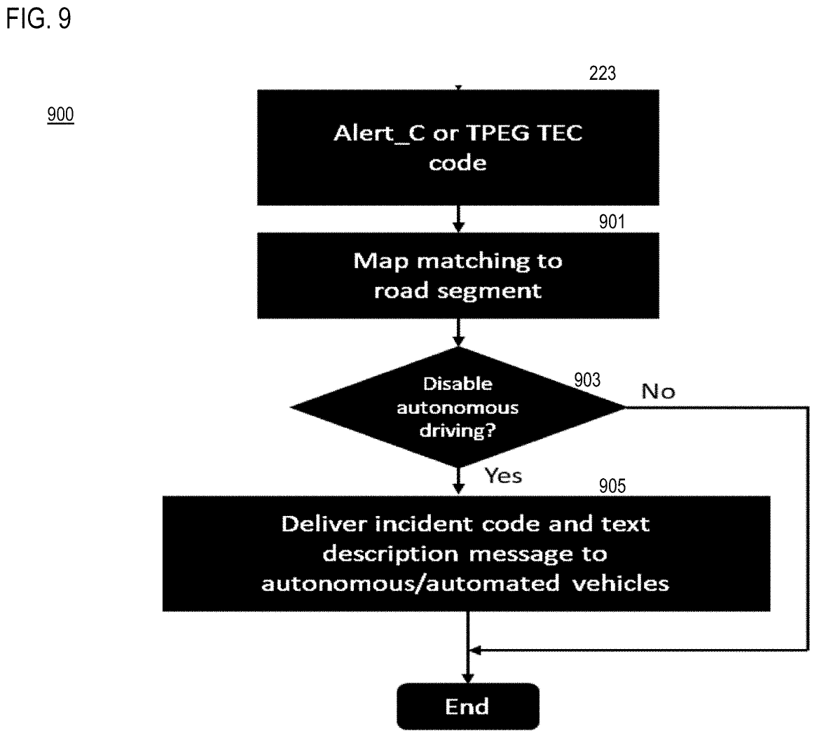

FIG. 9 is a flowchart of a process 900 for map-matching incident code thereby determining autonomous driving, according to one embodiment. In one embodiment, the map-matching module 303 can determine map-matching information for an incident associated with the hybrid incident output 223. The hybrid incident output 223 further includes the map-matching information.

By way of example, in step 901, the map-matching module 303 can map-match the hybrid incident output 223 (e.g., the Alert-C or TPEG TEC code) to identify which road, path, link, etc. a probe device (e.g., a vehicle 101, a UE 109, etc.) is travelling and a location of a traffic incident. The map matching process, for example, enables the data processing module 301 to correlate each location data point of the vehicle 101 and the traffic incident to a corresponding location on a segment of the road network, thereby determining how to operate an autonomous vehicle 101, for example whether to enable/disable autonomous driving in step 903. By way of example, the data processing module 301 determines that the vehicle 101 can circumvent a minor sidewalk repair event on the road segment in light traffic, and no need for disabling autonomous driving and ends the process 900. On the other hand, the data processing module 301 may determine that the vehicle 101 is approaching a major traffic jam on the road segment that requires driver's action to take a different route. The data processing module 301 can work with the output module 305 to transmit to the vehicle 101 a message (including an incident code, text description, autonomous driving disabling instruction, and further navigation directions, etc.) in step 905.

In another embodiment, the data processing module 301 may leave the autonomous driving enabling/disabling decision to the user in the vehicle 101. In this case, the data processing module 301 can work with the output module 305 to transmit to the vehicle 101 a message (including an incident code, text description, autonomous driving disabling recommendation, and further navigation directions, etc.).

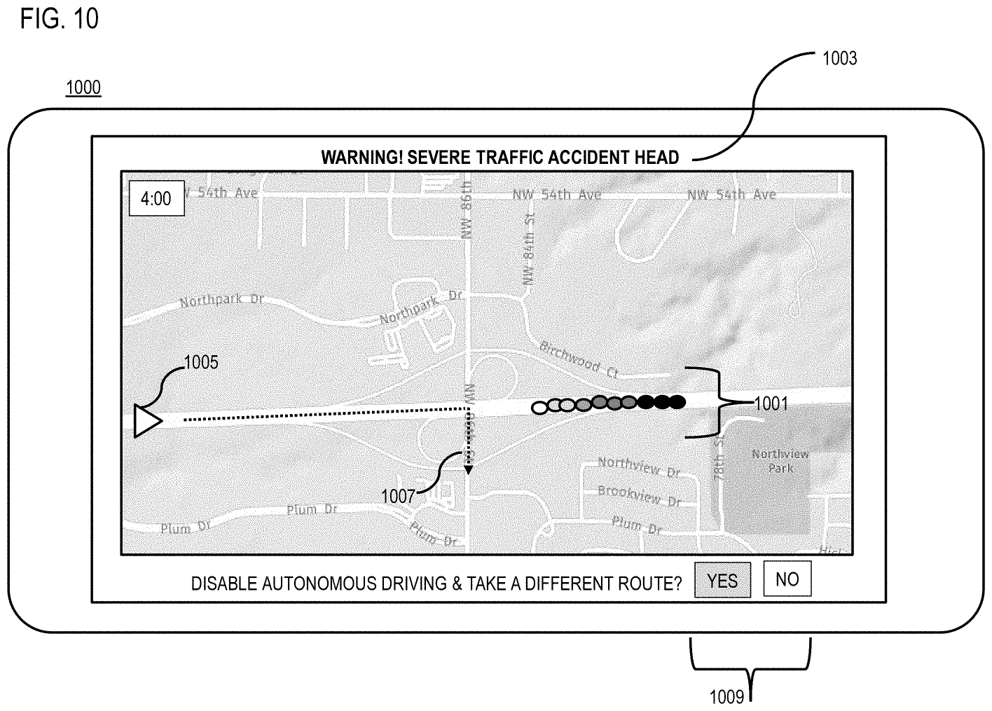

In one embodiment, the output module 305 may provide the output massage to a vehicle 101, a user of the vehicle 101 (e.g., a driver or a passenger), or a combination thereof via a UE 109 (e.g., an embedded navigation system, a mobile device, etc.) and/or an application 111 running on the UE 109 (e.g., a navigation application). FIG. 10 is a diagram of an example user interface 1000 depicting a traffic accident 1001 and an alert “Warning! Severe Traffic Accident Ahead” 1003, and a current location 1005 of the vehicle 101, according to one embodiment. The user interface 1000 shows a current time 4:00, an alternative route 1007, and a prompt 1009 of “Disable Autonomous Driving & Take a Different Route?”

In another embodiment, the data processing module 301 can determine a recommended route based on the hybrid incident output 223 using machine learning, and such machine learning route model accepts the hybrid incident output 223 as at least one input feature. In one embodiment, the machine learning system 123 can select respective weights of various traffic incident information sources, for example, based on their respective reliability. In another embodiment, the machine learning system 123 can further select or assign respective correlations, relationships, etc. among the traffic incident information sources, for determining a confidence level of a reported traffic incident. In one instance, the machine learning system 123 can continuously provide and/or update a machine learning route model using, for instance, supervised deep convolution networks or equivalents.

In one embodiment, the output module 305 can publish the hybrid incident output 223 in a geographic database (e.g., a road safety database, a real-time traffic reports RSS feed, the geographic database 115, etc.), a location-based service, or a combination thereof. By way of example, the location-based service is a navigation service, a traffic incident service, a package delivery service, a ride-hailing service, a ridesharing service, etc.

Returning to FIG. 1, in one embodiment, the traffic platform 105 has connectivity over the communication network 107 to the services platform 117 (e.g., an OEM platform) that provides one or more services 119a-119n (also collectively referred to herein as services 119) (e.g., probe and/or sensor data collection services). By way of example, the services 119 may also be other third-party services and include mapping services, navigation services, traffic incident services, travel planning services, notification services, social networking services, content (e.g., audio, video, images, etc.) provisioning services, application services, storage services, contextual information determination services, location-based services, information-based services (e.g., weather, news, etc.), etc. In one embodiment, the services platform 117 uses the output (e.g. lane-level dangerous slowdown event detection and messages) of the traffic platform 105 to provide services such as navigation, mapping, other location-based services, etc.

In one embodiment, the traffic platform 105 may be a platform with multiple interconnected components. The traffic platform 105 may include multiple servers, intelligent networking devices, computing devices, components, and corresponding software for providing parametric representations of lane lines. In addition, it is noted that the traffic platform 105 may be a separate entity of the system 100, a part of the services platform 117, a part of the one or more services 119, or included within the vehicles 101 (e.g., an embedded navigation system).

In one embodiment, content providers 121a-121m (also collectively referred to herein as content providers 121) may provide content or data (e.g., including probe data, sensor data, etc.) to the traffic platform 105, the UEs 109, the applications 111, the probe database 113, the geographic database 115, the services platform 117, the services 119, and the vehicles 101. The content provided may be any type of content, such as map content, textual content, audio content, video content, image content, etc. In one embodiment, the content providers 121 may provide content that may aid in localizing a vehicle path or trajectory on a lane of a digital map or link. In one embodiment, the content providers 121 may also store content associated with the traffic platform 105, the probe database 113, the geographic database 115, the services platform 117, the services 119, and/or the vehicles 101. In another embodiment, the content providers 121 may manage access to a central repository of data, and offer a consistent, standard interface to data, such as a repository of the geographic database 115.

By way of example, the UEs 109 are any type of embedded system, mobile terminal, fixed terminal, or portable terminal including a built-in navigation system, a personal navigation device, mobile handset, station, unit, device, multimedia computer, multimedia tablet, Internet node, communicator, desktop computer, laptop computer, notebook computer, netbook computer, tablet computer, personal communication system (PCS) device, personal digital assistants (PDAs), audio/video player, digital camera/camcorder, positioning device, fitness device, television receiver, radio broadcast receiver, electronic book device, game device, or any combination thereof, including the accessories and peripherals of these devices, or any combination thereof. It is also contemplated that a UE 109 can support any type of interface to the user (such as “wearable” circuitry, etc.). In one embodiment, a UE 109 may be associated with a vehicle 101 (e.g., a mobile device) or be a component part of the vehicle 101 (e.g., an embedded navigation system). In one embodiment, the UEs 109 may include the traffic platform 105 to provide hybrid traffic incident identification.

In one embodiment, as mentioned above, the vehicles 101, for instance, are part of a probe-based system for collecting probe data and/or sensor data for detecting traffic incidents (e.g., dangerous slowdown events) and/or measuring traffic conditions in a road network. In one embodiment, each vehicle 101 is configured to report probe data as probe points, which are individual data records collected at a point in time that records telemetry data for that point in time. In one embodiment, the probe ID can be permanent or valid for a certain period of time. In one embodiment, the probe ID is cycled, particularly for consumer-sourced data, to protect the privacy of the source.

In one embodiment, a probe point can include attributes such as: (1) probe ID, (2) longitude, (3) latitude, (4) heading, (5) speed, and (6) time. The list of attributes is provided by way of illustration and not limitation. Accordingly, it is contemplated that any combination of these attributes or other attributes may be recorded as a probe point. For example, attributes such as altitude (e.g., for flight capable vehicles or for tracking non-flight vehicles in the altitude domain), tilt, steering angle, wiper activation, etc. can be included and reported for a probe point. In one embodiment, the vehicles 101 may include sensors 103 for reporting measuring and/or reporting attributes. The attributes can also be any attribute normally collected by an on-board diagnostic (OBD) system of the vehicle 101, and available through an interface to the OBD system (e.g., OBD II interface or other similar interface).

The probe points can be reported from the vehicles 101 in real-time, in batches, continuously, or at any other frequency requested by the system 100 over, for instance, the communication network 107 for processing by the traffic platform 105. The probe points also can be map matched to specific road links stored in the geographic database 115. In one embodiment, the system 100 (e.g., via the traffic platform 105) can generate probe traces (e.g., vehicle paths or trajectories) from the probe points for an individual probe so that the probe traces represent a travel trajectory or vehicle path of the probe through the road network.

In one embodiment, as previously stated, the vehicles 101 are configured with various sensors (e.g., vehicle sensors 103) for generating or collecting probe data, sensor data, related geographic/map data, etc. In one embodiment, the sensed data represents sensor data associated with a geographic location or coordinates at which the sensor data was collected. In one embodiment, the probe data (e.g., stored in the probe database 113) includes location probes collected by one or more vehicle sensors 103. By way of example, the vehicle sensors 103 may include a RADAR system, a LiDAR system, global positioning sensor for gathering location data (e.g., GPS), a network detection sensor for detecting wireless signals or receivers for different short-range communications (e.g., Bluetooth, Wi-Fi, Li-Fi, near field communication (NFC) etc.), temporal information sensors, a camera/imaging sensor for gathering image data, an audio recorder for gathering audio data, velocity sensors mounted on a steering wheel of the vehicles 101, switch sensors for determining whether one or more vehicle switches are engaged, and the like. Though depicted as automobiles, it is contemplated the vehicles 101 can be any type of vehicle manned or unmanned (e.g., cars, trucks, buses, vans, motorcycles, scooters, drones, etc.) that travel through road segments of a road network.

Other examples of sensors 103 of the vehicle 101 may include light sensors, orientation sensors augmented with height sensors and acceleration sensor (e.g., an accelerometer can measure acceleration and can be used to determine orientation of the vehicle), tilt sensors to detect the degree of incline or decline of the vehicle 101 along a path of travel (e.g., while on a hill or a cliff), moisture sensors, pressure sensors, etc. In a further example embodiment, sensors 103 about the perimeter of the vehicle 101 may detect the relative distance of the vehicle 101 from a physical divider, a lane line of a link or roadway, the presence of other vehicles, pedestrians, traffic lights, potholes and any other objects, or a combination thereof. In one scenario, the vehicle sensors 103 may detect weather data, traffic information, or a combination thereof. In one embodiment, the vehicles 101 may include GPS or other satellite-based receivers 103 to obtain geographic coordinates from satellites 125 for determining current location and time. Further, the location can be determined by visual odometry, triangulation systems such as A-GPS, Cell of Origin, or other location extrapolation technologies.

In one embodiment, the UEs 109 may also be configured with various sensors (not shown for illustrative convenience) for acquiring and/or generating probe data and/or sensor data associated with a vehicle 101, a driver, other vehicles, conditions regarding the driving environment or roadway, etc. For example, such sensors may be used as GPS receivers for interacting with the one or more satellites 125 to determine and track the current speed, position, and location of a vehicle 101 travelling along a link or roadway. In addition, the sensors may gather tilt data (e.g., a degree of incline or decline of the vehicle during travel), motion data, light data, sound data, image data, weather data, temporal data and other data associated with the vehicles 101 and/or UEs 109. Still further, the sensors may detect local or transient network and/or wireless signals, such as those transmitted by nearby devices during navigation of a vehicle along a roadway (Li-Fi, near field communication (NFC)) etc.

It is noted therefore that the above described data may be transmitted via communication network 107 as probe data (e.g., GPS probe data) according to any known wireless communication protocols. For example, each UE 109, application 111, user, and/or vehicle 101 may be assigned a unique probe identifier (probe ID) for use in reporting or transmitting said probe data collected by the vehicles 101 and/or UEs 109. In one embodiment, each vehicle 101 and/or UE 109 is configured to report probe data as probe points, which are individual data records collected at a point in time that records telemetry data.

In one embodiment, the traffic platform 105 retrieves aggregated probe points gathered and/or generated by the vehicle sensors 103 and/or the UE 109 resulting from the travel of the UEs 109 and/or vehicles 101 on a road segment of a road network. In one instance, the probe database 113 stores a plurality of probe points and/or trajectories generated by different vehicle sensors 103, UEs 109, applications 111, vehicles 101, etc. over a period while traveling in a monitored area. A time sequence of probe points specifies a trajectory—i.e., a path traversed by a UE 109, application 111, vehicle 101, etc. over the period.

In one embodiment, the communication network 107 of the system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

By way of example, the vehicles 101, vehicle sensors 103, traffic platform 105, UEs 109, applications 111, services platform 117, services 119, content providers 121, and/or satellites 125 communicate with each other and other components of the system 100 using well known, new or still developing protocols. In this context, a protocol includes a set of rules defining how the network nodes within the communication network 107 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

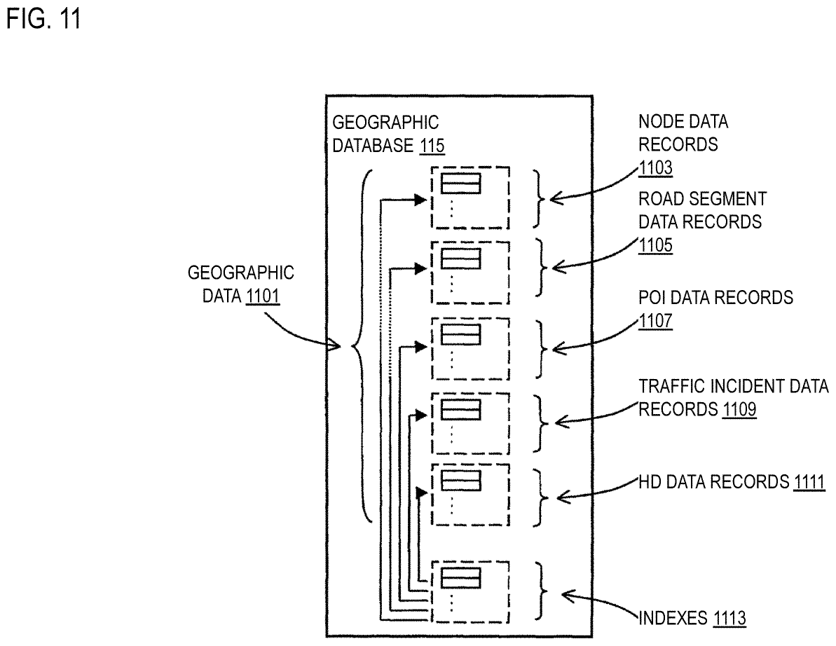

FIG. 11 is a diagram of a geographic database (such as the database 115), according to one embodiment. In one embodiment, the geographic database 115 includes geographic data 1101 used for (or configured to be compiled to be used for) mapping and/or navigation-related services, such as for video odometry based on the parametric representation of lanes include, e.g., encoding and/or decoding parametric representations into lane lines. In one embodiment, the geographic database 115 include high resolution or high definition (HD) mapping data that provide centimeter-level or better accuracy of map features. For example, the geographic database 115 can be based on Light Detection and Ranging (LiDAR) or equivalent technology to collect billions of 3D points and model road surfaces and other map features down to the number lanes and their widths. In one embodiment, the HD mapping data (e.g., HD data records 1111) capture and store details such as the slope and curvature of the road, lane markings, roadside objects such as signposts, including what the signage denotes. By way of example, the HD mapping data enable highly automated vehicles to precisely localize themselves on the road.

In one embodiment, geographic features (e.g., two-dimensional, or three-dimensional features) are represented using polygons (e.g., two-dimensional features) or polygon extrusions (e.g., three-dimensional features). For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three-dimensional polygon extrusions. Accordingly, the terms polygons and polygon extrusions as used herein can be used interchangeably.

In one embodiment, the following terminology applies to the representation of geographic features in the geographic database 115.

“Line segment”—A straight line connecting two points.

“Link” (or “edge”)—A contiguous, non-branching string of one or more line segments terminating in a node at each end.

“Shape point”—A point along a link between two nodes (e.g., used to alter a shape of the link without defining new nodes).

“Oriented link”—A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 115 follows certain conventions. For example, links do not cross themselves and do not cross each other except at a node. Also, there are no duplicated shape points, nodes, or links. Two links that connect each other have a common node. In the geographic database 115, overlapping geographic features are represented by overlapping polygons. When polygons overlap, the boundary of one polygon crosses the boundary of the other polygon. In the geographic database 115, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the geographic database 115 includes node data records 1103, road segment or link data records 1105, POI data records 1107, traffic incident data records 1109, HD mapping data records 1111, and indexes 1113, for example. More, fewer, or different data records can be provided. In one embodiment, additional data records (not shown) can include cartographic (“carto”) data records, routing data, and maneuver data. In one embodiment, the indexes 1113 may improve the speed of data retrieval operations in the geographic database 115. In one embodiment, the indexes 1113 may be used to quickly locate data without having to search every row in the geographic database 115 every time it is accessed. For example, in one embodiment, the indexes 1113 can be a spatial index of the polygon points associated with stored feature polygons.

In exemplary embodiments, the road segment data records 1105 are links or segments representing roads, streets, or paths, as can be used in the calculated route or recorded route information for determination of one or more personalized routes. The node data records 1103 are end points corresponding to the respective links or segments of the road segment data records 1105. The road link data records 1105 and the node data records 1103 represent a road network, such as used by vehicles, cars, and/or other entities. Alternatively, the geographic database 115 can contain path segment and node data records or other data that represent pedestrian paths or areas in addition to or instead of the vehicle road record data, for example.

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 115 can include data about the POIs and their respective locations in the POI data records 1107. The geographic database 115 can also include data about places, such as cities, towns, or other communities, and other geographic features, such as bodies of water, mountain ranges, etc. Such place or feature data can be part of the POI data records 1107 or can be associated with POIs or POI data records 1107 (such as a data point used for displaying or representing a position of a city).

In one embodiment, the geographic database 115 can also include traffic incident data records 1109 for storing the traffic incident information 211, the well-formatted data 213, the non-well-formatted data 217, the incident content 219, the hybrid incident output 223, the RDS-TMC and/or TPEG TEC incident code with text descriptions, traffic incident reporting format conversion tables, training data, prediction models, computed featured distributions, sampling probabilities, and/or any other data generated or used by the system 100 according to the various embodiments described herein. By way of example, the traffic incident data records 1109 can be associated with one or more of the node records 1103, road segment records 1105, and/or POI data records 1107 to support hybrid traffic incident identification based on the parameters and/or features stored therein and the corresponding estimated confidence levels of the traffic incidents. In this way, the records 1109 can also be associated with or used to classify the characteristics or metadata of the corresponding records 1103, 1105, and/or 1107.

In one embodiment, as discussed above, the HD mapping data records 1111 model road surfaces and other map features to centimeter-level or better accuracy. The HD mapping data records 1111 also include lane models that provide the precise lane geometry with lane boundaries, as well as rich attributes of the lane models. These rich attributes include, but are not limited to, lane traversal information, lane types, lane marking types, lane level speed limit information, and/or the like. In one embodiment, the HD mapping data records 1111 are divided into spatial partitions of varying sizes to provide HD mapping data to vehicles 101 and other end user devices with near real-time speed without overloading the available resources of the vehicles 101 and/or devices (e.g., computational, memory, bandwidth, etc. resources).

In one embodiment, the HD mapping data records 1111 are created from high-resolution 3D mesh or point-cloud data generated, for instance, from LiDAR-equipped vehicles. The 3D mesh or point-cloud data are processed to create 3D representations of a street or geographic environment at centimeter-level accuracy for storage in the HD mapping data records 1111.

In one embodiment, the HD mapping data records 1111 also include real-time sensor data collected from probe vehicles in the field. The real-time sensor data, for instance, integrates real-time traffic information, weather, and road conditions (e.g., potholes, road friction, road wear, etc.) with highly detailed 3D representations of street and geographic features to provide precise real-time also at centimeter-level accuracy. Other sensor data can include vehicle telemetry or operational data such as windshield wiper activation state, braking state, steering angle, accelerator position, and/or the like.

In one embodiment, the geographic database 115 can be maintained by the content provider 121 in association with the services platform 117 (e.g., a map developer). The map developer can collect geographic data to generate and enhance the geographic database 115. There can be different ways used by the map developer to collect data. These ways can include obtaining data from other sources, such as municipalities or respective geographic authorities. In addition, the map developer can employ field personnel to travel by vehicle (e.g., vehicles 101 and/or user terminals 109) along roads throughout the geographic region to observe features and/or record information about them, for example. Also, remote sensing, such as aerial or satellite photography, can be used.

The geographic database 115 can be a master geographic database stored in a format that facilitates updating, maintenance, and development. For example, the master geographic database or data in the master geographic database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a vehicle 101 or a UE 109, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for providing hybrid traffic incident identification may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

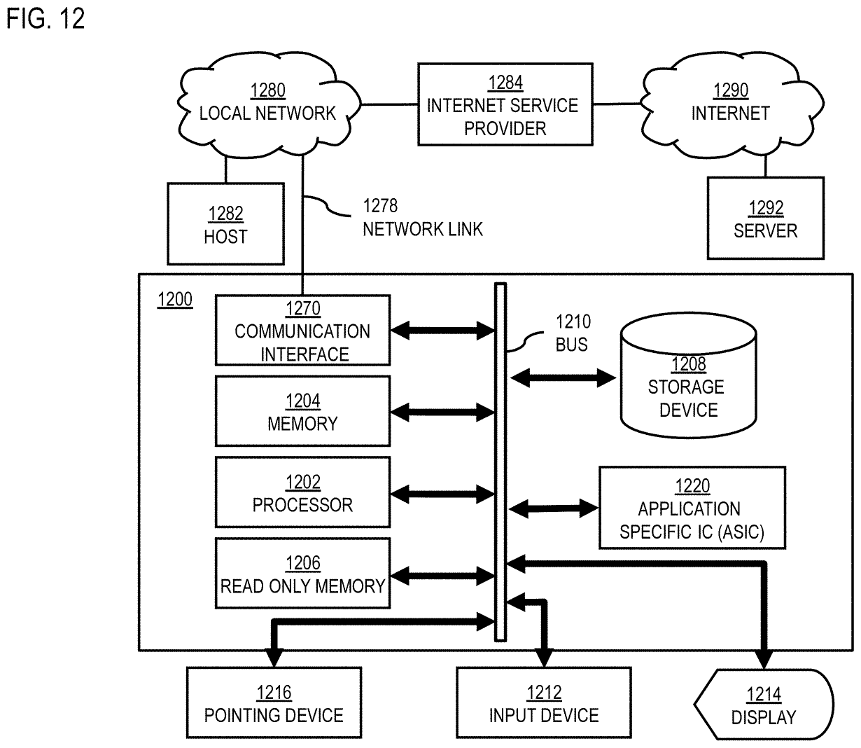

FIG. 12 illustrates a computer system 1200 upon which an embodiment of the invention may be implemented. Computer system 1200 is programmed (e.g., via computer program code or instructions) to provide hybrid traffic incident identification as described herein and includes a communication mechanism such as a bus 1210 for passing information between other internal and external components of the computer system 1200. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 1210 includes one or more parallel conductors of information so that information is transferred quickly among devices coupled to the bus 1210. One or more processors 1202 for processing information are coupled with the bus 1210.

A processor 1202 performs a set of operations on information as specified by computer program code related to providing hybrid traffic incident identification. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1210 and placing information on the bus 1210. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1202, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 1200 also includes a memory 1204 coupled to bus 1210. The memory 1204, such as a random access memory (RAM) or other dynamic storage device, stores information including processor instructions for providing hybrid traffic incident identification. Dynamic memory allows information stored therein to be changed by the computer system 1200. RAM allows a unit of information stored at a location called a memory address to be stored and retrieved independently of information at neighboring addresses. The memory 1204 is also used by the processor 1202 to store temporary values during execution of processor instructions. The computer system 1200 also includes a read only memory (ROM) 1206 or other static storage device coupled to the bus 1210 for storing static information, including instructions, that is not changed by the computer system 1200. Some memory is composed of volatile storage that loses the information stored thereon when power is lost. Also coupled to bus 1210 is a non-volatile (persistent) storage device 1208, such as a magnetic disk, optical disk, or flash card, for storing information, including instructions, that persists even when the computer system 1200 is turned off or otherwise loses power.

Information, including instructions for providing hybrid traffic incident identification, is provided to the bus 1210 for use by the processor from an external input device 1212, such as a keyboard containing alphanumeric keys operated by a human user, or a sensor. A sensor detects conditions in its vicinity and transforms those detections into physical expression compatible with the measurable phenomenon used to represent information in computer system 1200. Other external devices coupled to bus 1210, used primarily for interacting with humans, include a display device 1214, such as a cathode ray tube (CRT) or a liquid crystal display (LCD), or plasma screen or printer for presenting text or images, and a pointing device 1216, such as a mouse or a trackball or cursor direction keys, or motion sensor, for controlling a position of a small cursor image presented on the display 1214 and issuing commands associated with graphical elements presented on the display 1214. In some embodiments, for example, in embodiments in which the computer system 1200 performs all functions automatically without human input, one or more of external input device 1212, display device 1214 and pointing device 1216 is omitted.

In the illustrated embodiment, special purpose hardware, such as an application specific integrated circuit (ASIC) 1220, is coupled to bus 1210. The special purpose hardware is configured to perform operations not performed by processor 1202 quickly enough for special purposes. Examples of application specific ICs include graphics accelerator cards for generating images for display 1214, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1200 also includes one or more instances of a communications interface 1270 coupled to bus 1210. Communication interface 1270 provides a one-way or two-way communication coupling to a variety of external devices that operate with their own processors, such as printers, scanners, and external disks. In general the coupling is with a network link 1278 that is connected to a local network 1280 to which a variety of external devices with their own processors are connected. For example, communication interface 1270 may be a parallel port or a serial port or a universal serial bus (USB) port on a personal computer. In some embodiments, communications interface 1270 is an integrated services digital network (ISDN) card or a digital subscriber line (DSL) card or a telephone modem that provides an information communication connection to a corresponding type of telephone line. In some embodiments, a communication interface 1270 is a cable modem that converts signals on bus 1210 into signals for a communication connection over a coaxial cable or into optical signals for a communication connection over a fiber optic cable. As another example, communications interface 1270 may be a local area network (LAN) card to provide a data communication connection to a compatible LAN, such as Ethernet. Wireless links may also be implemented. For wireless links, the communications interface 1270 sends or receives or both sends and receives electrical, acoustic, or electromagnetic signals, including infrared and optical signals, that carry information streams, such as digital data. For example, in wireless handheld devices, such as mobile telephones like cell phones, the communications interface 1270 includes a radio band electromagnetic transmitter and receiver called a radio transceiver. In certain embodiments, the communications interface 1270 enables connection to the communication network 107 for providing hybrid traffic incident identification to the vehicle 101.

The term computer-readable medium is used herein to refer to any medium that participates in providing information to processor 1202, including instructions for execution. Such a medium may take many forms, including, but not limited to, non-volatile media, volatile media, and transmission media. Non-volatile media include, for example, optical or magnetic disks, such as storage device 1208. Volatile media include, for example, dynamic memory 1204.

Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization, or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Network link 1278 typically provides information communication using transmission media through one or more networks to other devices that use or process the information. For example, network link 1278 may provide a connection through local network 1280 to a host computer 1282 or to equipment 1284 operated by an Internet Service Provider (ISP). ISP equipment 1284 in turn provides data communication services through the public, world-wide packet-switching communication network of networks now commonly referred to as the Internet 1290.

A computer called a server host 1292 connected to the Internet hosts a process that provides a service in response to information received over the Internet. For example, server host 1292 hosts a process that provides information representing video data for presentation at display 1214. It is contemplated that the components of system can be deployed in various configurations within other computer systems, e.g., host 1282 and server 1292.

FIG. 13 illustrates a chip set 1300 upon which an embodiment of the invention may be implemented. Chip set 1300 is programmed to provide hybrid traffic incident identification as described herein and includes, for instance, the processor and memory components described with respect to FIG. 12 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 1300 includes a communication mechanism such as a bus 1301 for passing information among the components of the chip set 1300. A processor 1303 has connectivity to the bus 1301 to execute instructions and process information stored in, for example, a memory 1305. The processor 1303 may include one or more processing cores with each core configured to perform independently. A multi-core processor enables multiprocessing within a single physical package. Examples of a multi-core processor include two, four, eight, or greater numbers of processing cores. Alternatively or in addition, the processor 1303 may include one or more microprocessors configured in tandem via the bus 1301 to enable independent execution of instructions, pipelining, and multithreading. The processor 1303 may also be accompanied with one or more specialized components to perform certain processing functions and tasks such as one or more digital signal processors (DSP) 1307, or one or more application-specific integrated circuits (ASIC) 1309. A DSP 1307 typically is configured to process real-world signals (e.g., sound) in real time independently of the processor 1303. Similarly, an ASIC 1309 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1303 and accompanying components have connectivity to the memory 1305 via the bus 1301. The memory 1305 includes both dynamic memory (e.g., RAM, magnetic disk, writable optical disk, etc.) and static memory (e.g., ROM, CD-ROM, etc.) for storing executable instructions that when executed perform the inventive steps described herein to provide hybrid traffic incident identification. The memory 1305 also stores the data associated with or generated by the execution of the inventive steps.

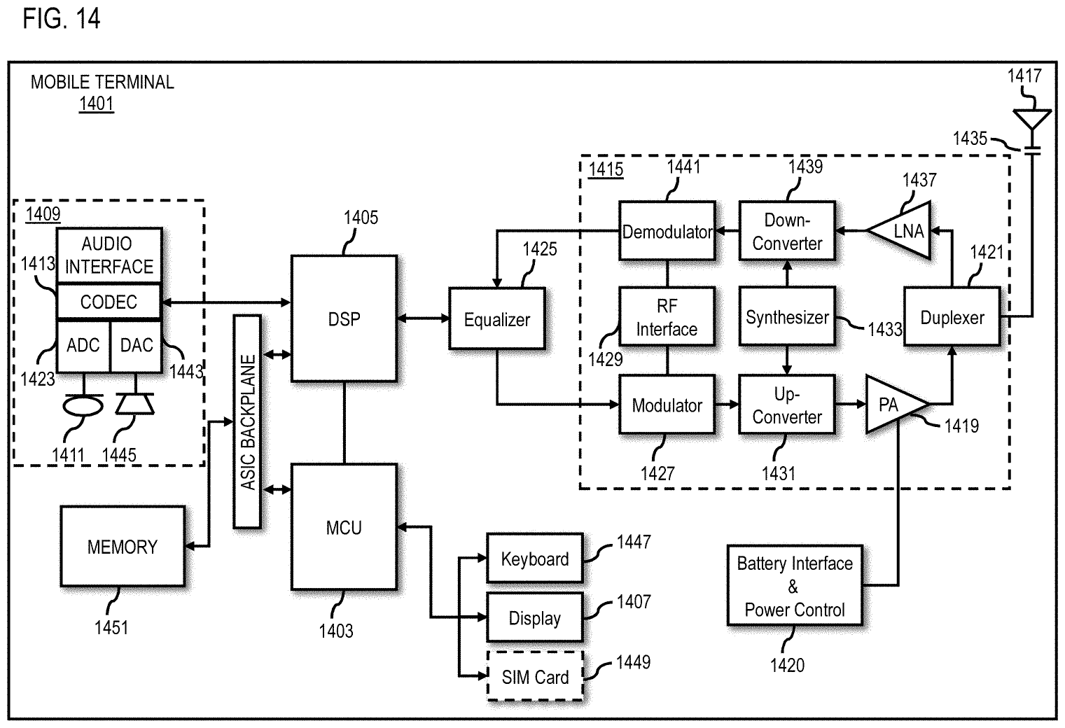

FIG. 14 is a diagram of exemplary components of a mobile terminal (e.g., handset) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 1403, a Digital Signal Processor (DSP) 1405, and a receiver/transmitter unit including a microphone gain control unit and a speaker gain control unit. A main display unit 1407 provides a display to the user in support of various applications and mobile station functions that offer automatic contact matching. An audio function circuitry 1409 includes a microphone 1411 and microphone amplifier that amplifies the speech signal output from the microphone 1411. The amplified speech signal output from the microphone 1411 is fed to a coder/decoder (CODEC) 1413.

A radio section 1415 amplifies power and converts frequency in order to communicate with a base station, which is included in a mobile communication system, via antenna 1417. The power amplifier (PA) 1419 and the transmitter/modulation circuitry are operationally responsive to the MCU 1403, with an output from the PA 1419 coupled to the duplexer 1421 or circulator or antenna switch, as known in the art. The PA 1419 also couples to a battery interface and power control unit 1420.

In use, a user of mobile station 1401 speaks into the microphone 1411 and his or her voice along with any detected background noise is converted into an analog voltage. The analog voltage is then converted into a digital signal through the Analog to Digital Converter (ADC) 1423. The control unit 1403 routes the digital signal into the DSP 1405 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 1425 for compensation of any frequency-dependent impairments that occur during transmission though the air such as phase and amplitude distortion. After equalizing the bit stream, the modulator 1427 combines the signal with a RF signal generated in the RF interface 1429. The modulator 1427 generates a sine wave by way of frequency or phase modulation. In order to prepare the signal for transmission, an up-converter 1431 combines the sine wave output from the modulator 1427 with another sine wave generated by a synthesizer 1433 to achieve the desired frequency of transmission. The signal is then sent through a PA 1419 to increase the signal to an appropriate power level. In practical systems, the PA 1419 acts as a variable gain amplifier whose gain is controlled by the DSP 1405 from information received from a network base station. The signal is then filtered within the duplexer 1421 and optionally sent to an antenna coupler 1435 to match impedances to provide maximum power transfer. Finally, the signal is transmitted via antenna 1417 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1401 are received via antenna 1417 and immediately amplified by a low noise amplifier (LNA) 1437. A down-converter 1439 lowers the carrier frequency while the demodulator 1441 strips away the RF leaving only a digital bit stream. The signal then goes through the equalizer 1425 and is processed by the DSP 1405. A Digital to Analog Converter (DAC) 1443 converts the signal and the resulting output is transmitted to the user through the speaker 1445, all under control of a Main Control Unit (MCU) 1403—which can be implemented as a Central Processing Unit (CPU) (not shown).

The MCU 1403 receives various signals including input signals from the keyboard 1447. The keyboard 1447 and/or the MCU 1403 in combination with other user input components (e.g., the microphone 1411) comprise a user interface circuitry for managing user input. The MCU 1403 runs a user interface software to facilitate user control of at least some functions of the mobile station 1401 to provide hybrid traffic incident identification. The MCU 1403 also delivers a display command and a switch command to the display 1407 and to the speech output switching controller, respectively. Further, the MCU 1403 exchanges information with the DSP 1405 and can access an optionally incorporated SIM card 1449 and a memory 1451. In addition, the MCU 1403 executes various control functions required of the station. The DSP 1405 may, depending upon the implementation, perform any of a variety of conventional digital processing functions on the voice signals. Additionally, DSP 1405 determines the background noise level of the local environment from the signals detected by microphone 1411 and sets the gain of microphone 1411 to a level selected to compensate for the natural tendency of the user of the mobile station 1401.

The CODEC 1413 includes the ADC 1423 and DAC 1443. The memory 1451 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 1451 may be, but not limited to, a single memory, CD, DVD, ROM, RAM, EEPROM, optical storage, or any other non-volatile or non-transitory storage medium capable of storing digital data.

An optionally incorporated SIM card 1449 carries, for instance, important information, such as the cellular phone number, the carrier supplying service, subscription details, and security information. The SIM card 1449 serves primarily to identify the mobile station 1401 on a radio network. The card 1449 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
processing traffic incident information received from at least one incident source to classify the traffic incident information as either well-formatted data or non-well-formatted data, wherein the well-formatted data indicates that the traffic incident information matches at least one previously stored incident code, and wherein the non-well-formatted data indicates that the traffic incident information does not match the previously stored incident code;
converting the well-formatted data to an incident reporting format to generate a first output portion;
extracting incident content from the non-well-formatted data, wherein the extracted incident content represents the traffic incident information based on the at least one previously stored incident code;
converting the extracted incident content to the incident reporting format to generate a second output portion; and
providing the first output portion, the second output portion, or a combination thereof as a hybrid incident output.

2. The method of claim 1, wherein the hybrid incident output is provided for operating an autonomous vehicle.

3. The method of claim 1, wherein an autonomous operation of the autonomous vehicle is enabled or disabled based on the hybrid incident output.

4. The method of claim 1, further comprising:
reformatting the well-formatted data into structural data based on the at least one previously stored code,
wherein the structural data is converted to the incident reporting format to generate the first output portion based on matching the structural data to an incident log pattern.

5. The method of claim 1, further comprising:
determining an incident type, an incident severity, a confidence level, or a combination of the structured data based on the traffic incident information, the well-formatted data, the non-well-formatted data, the extracted incident content, or a combination thereof,
wherein the hybrid incident output includes the incident type, the incident severity, the confidence level, or a combination thereof.

6. The method of claim 1, further comprising:
determining map-matching information for an incident associated with the hybrid incident output,
wherein the hybrid incident output further includes the map-matching information.

7. The method of claim 1, wherein the traffic incident information includes non-textual data, the method further comprising:
converting the non-textual data to textual data to generate the well-formatted data, the non-well-formatted data, or a combination thereof.

8. The method of claim 1, wherein the at least one previously stored code is included in a database of a plurality of reference incident codes associated with the incident reporting format.

9. The method of claim 1, further comprising:
publishing the hybrid incident report in a geographic database, a location-based service, or a combination thereof.

10. The method of claim 1, wherein the incident reporting format follows alert-c code or transport protocol experts group traffic event compact code.

11. An apparatus comprising:
at least one processor; and
at least one memory including computer program code for one or more programs,
the at least one memory and the computer program code configured to, with the at least one processor, cause the apparatus to perform at least the following,
process traffic incident information received from at least one incident source to classify the traffic incident information as either well-formatted data or non-well-formatted data, wherein the well-formatted data indicates that the traffic incident information matches at least one previously stored incident code, and wherein the non-well-formatted data indicates that the traffic incident information does not match the previously stored incident code;
convert the well-formatted data to an incident reporting format to generate a first output portion;
extract incident content from the non-well-formatted data, wherein the extracted incident content represents the traffic incident information based on the at least one previously stored incident code;
convert the extracted incident content to the incident reporting format to generate a second output portion; and
provide the first output portion, the second output portion, or a combination thereof as a hybrid incident output.

12. The apparatus of claim 11, wherein the hybrid incident output is provided for operating an autonomous vehicle.

13. The apparatus of claim 11, wherein an autonomous operation of the autonomous vehicle is enabled or disabled based on the hybrid incident output.

14. The apparatus of claim 11, wherein the apparatus is further caused to:
reformat the well-formatted data into structural data based on the at least one previously stored code,
wherein the structural data is converted to the incident reporting format to generate the first output portion based on matching the structural data to an incident log pattern.

15. The apparatus of claim 11, wherein the apparatus is further caused to:
determine an incident type, an incident severity, a confidence level, or a combination of the structured data based on the traffic incident information, the well-formatted data, the non-well-formatted data, the extracted incident content, or a combination thereof,
wherein the hybrid incident output includes the incident type, the incident severity, the confidence level, or a combination thereof.

16. The apparatus of claim 11, wherein the apparatus is further caused to:
determine map-matching information for an incident associated with the hybrid incident output,
wherein the hybrid incident output further includes the map-matching information.

17. The apparatus of claim 11, wherein the traffic incident information includes non-textual data, and the apparatus is further caused to:
convert the non-textual data to textual data to generate the well-formatted data, the non-well-formatted data, or a combination thereof.

18. A non-transitory computer-readable storage medium, carrying one or more sequences of one or more instructions which, when executed by one or more processors, cause an apparatus to at least perform the following steps:
processing traffic incident information received from at least one incident source to classify the traffic incident information as either well-formatted data or non-well-formatted data, wherein the well-formatted data indicates that the traffic incident information matches at least one previously stored incident code, and wherein the non-well-formatted data indicates that the traffic incident information does not match the previously stored incident code;
converting the well-formatted data to an incident reporting format to generate a first output portion;
extracting incident content from the non-well-formatted data, wherein the extracted incident content represents the traffic incident information based on the at least one previously stored incident code;
converting the extracted incident content to the incident reporting format to generate a second output portion; and
providing the first output portion, the second output portion, or a combination thereof as a hybrid incident output.

19. The non-transitory computer-readable storage medium of claim 18, wherein the hybrid incident output is provided for operating an autonomous vehicle.

20. The non-transitory computer-readable storage medium of claim 18, wherein an autonomous operation of the autonomous vehicle is enabled or disabled based on the hybrid incident output.
